(19) United States
(12) Patent Application Publication
(10) Pub. No.: US 2026/0054750 A1
(43) Pub. Date: Feb. 26, 2026

(54) VEHICLE CONTROL METHOD AND VEHICLE CONTROL DEVICE

(71) Applicant: Panasonic Automotive Systems Co., Ltd., Kanagawa (JP)

(72) Inventors: Takaya DEGUCHI, Kanagawa Ken (JP); Hirofumi NISHIMURA, Kanagawa Ken (JP); Yoshimasa OKABE, Kanagawa Ken (JP)

(73) Assignee: Panasonic Automotive Systems Co., Ltd., Kanagawa (JP)

(21) Appl. No.: 19/293,946

(22) Filed: Aug. 7, 2025

(30) Foreign Application Priority Data
Aug. 20, 2024 (JP) 2024-139109

(51) Int. Cl. B60W 60/00; B60W 10/04; B60W 10/18; B60W 10/20; B60W 30/06; B60W 30/09; B60W 50/14; G08G 1/16

(52) U.S. Cl. CPC B60W 60/0017; B60W 10/04; B60W 10/18; B60W 10/20; B60W 30/06; B60W 30/09; B60W 50/14; B60W 60/005; G08G 1/16; B60W 2050/146; B60W 2420/403; B60W 2420/408; B60W 2420/54; B60W 2510/18; B60W 2540/215; B60W 2554/4029; B60W 2554/4041; B60W 2710/18; B60W 2710/20; B60W 2720/106

(57) ABSTRACT

A vehicle control method including: causing a vehicle to perform autonomous travel by controlling at least acceleration and deceleration and steering based on a situation outside acquired by a sensor device; decelerating the vehicle at a predetermined deceleration and stopping the vehicle, deactivating the autonomous travel, and displaying on a display device that the autonomous travel has been interrupted, when determining that the situation outside acquired by the sensor device satisfies a first condition during the autonomous travel; and displaying on the display device that the autonomous travel will be resumed when a brake operation is released after the brake operation when determining that the situation outside acquired by the sensor device satisfies a second condition after deactivating the autonomous travel, and resuming the autonomous travel in a case where the operation device receives a first operation of releasing the brake operation after the brake operation.

### CROSS-REFERENCE TO RELATED APPLICATIONS

This application is based upon and claims the benefit of priority from Japanese Patent Application No. 2024-139109, filed on Aug. 20, 2024, the entire contents of which are incorporated herein by reference.

### FIELD

Embodiments described herein relate generally to a vehicle control method and a vehicle control device.

### BACKGROUND

A technology in which autonomous travel is deactivated in a case where an obstacle is detected around a vehicle during the autonomous travel such as automated parking, and the vehicle is decelerated and stopped is disclosed (see JP 6998358 B2).

After the autonomous travel of the vehicle is deactivated and the vehicle decelerates and stops, an occupant may desire to resume the autonomous travel. However, according to the related art, an operation method for resuming the autonomous travel is not provided, and it may be difficult to provide suitable resumption control for the autonomous travel.

### SUMMARY

A vehicle control method according to the present disclosure is executed by a vehicle control device mounted on a vehicle including an operation device, a sensor device, a display device, and a movement control device. The operation device receives an operation of an occupant. The sensor device acquires a situation outside. The display device is visually recognizable by the occupant. The movement control device controls at least acceleration and deceleration and steering. The vehicle control method including: causing the vehicle to perform autonomous travel by controlling at least the acceleration and deceleration and the steering based on the situation outside acquired by the sensor device; decelerating the vehicle at a predetermined deceleration and stopping the vehicle, deactivating the autonomous travel, and displaying on the display device that the autonomous travel has been interrupted, when determining that the situation outside acquired by the sensor device satisfies a first condition during the autonomous travel; and displaying on the display device that the autonomous travel will be resumed when a brake operation is released after the brake operation when determining that the situation outside acquired by the sensor device satisfies a second condition after deactivating the autonomous travel, and resuming the autonomous travel in a case where the operation device receives a first operation of releasing the brake operation after the brake operation.

### BRIEF DESCRIPTION OF THE DRAWINGS

FIG. 1 is a block diagram illustrating an example of an overall configuration of a vehicle;

FIG. 2 is a schematic diagram illustrating an example of disposition of cameras;

FIG. 3 is an explanatory diagram of an example of a teaching path;

FIG. 4 is a schematic diagram of an example of a first screen;

FIG. 5 is a schematic diagram of an example of a second screen;

FIG. 6 is a schematic diagram of an example of a third screen;

FIG. 7 is a schematic diagram of an example of a fourth screen;

FIG. 8 is a schematic diagram of an example of a fifth screen;

FIG. 9 is a flowchart illustrating an example of a flow of information processing executed by the control circuit in an autonomous travel mode; and

FIG. 10 is a block diagram illustrating a hardware configuration example.

### DETAILED DESCRIPTION

Hereinafter, embodiments of a vehicle control method and a vehicle control device according to the present disclosure will be described with reference to the drawings.

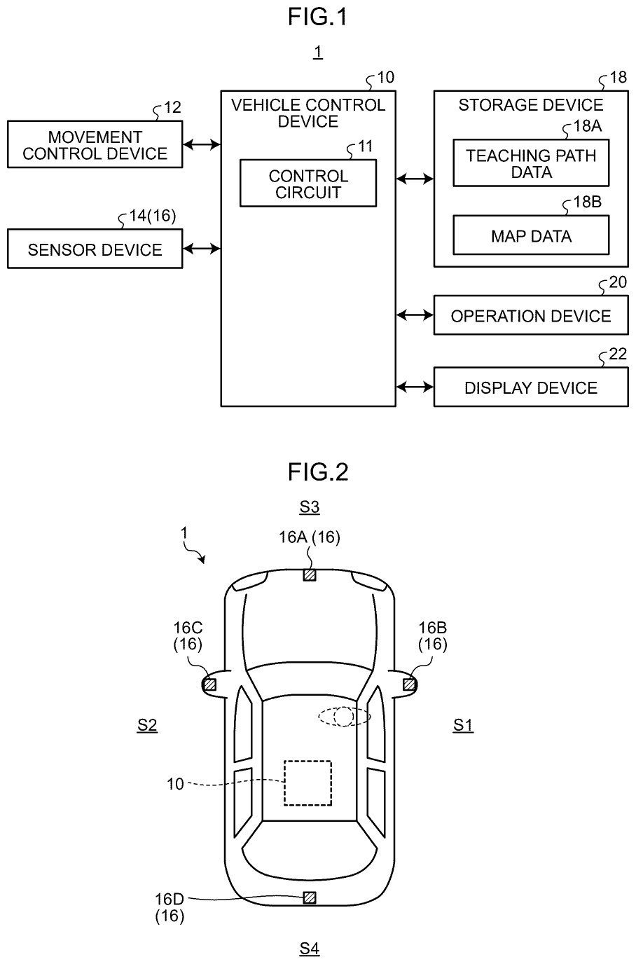

FIG. 1 is a block diagram illustrating an example of an overall configuration of a vehicle 1.

The vehicle 1 includes a vehicle control device 10, a movement control device 12, a sensor device 14, a storage device 18, an operation device 20, and a display device 22.

The movement control device 12, the sensor device 14, the storage device 18, the operation device 20, and the display device 22 are connected to the vehicle control device 10 so as to be able to exchange data or a signal. That is, the vehicle control device 10 is set to be communicably connected to at least the sensor device 14, the operation device 20, the display device 22, and the movement control device 12.

The movement control device 12 controls at least acceleration and deceleration and steering of the vehicle 1. The movement control device 12 is means for implementing driving, braking, and turning motions necessary for traveling of the vehicle 1. For example, the movement control device 12 includes a drive motor, a power transmission mechanism, a brake device, a steering device, and the like, and an electronic vehicle control device that controls the drive motor, the power transmission mechanism, the brake device, the steering device, and the like. The movement control device 12 causes the vehicle 1 to travel by, for example, generating power with the drive motor and transmitting the power to wheels via the power transmission mechanism. The power transmission mechanism is, for example, a propeller shaft, a differential gear, a drive shaft, or the like.

Controlling at least the acceleration and deceleration means that the movement control device 12 controls at least one of the driving and braking necessary for the traveling of the vehicle 1. That is, controlling the acceleration and deceleration means that the movement control device 12 controls an acceleration applied during the acceleration and a deceleration which is an acceleration applied during the deceleration.

Controlling at least the steering means that the movement control device 12 controls at least one of the driving, braking, and turning motions necessary for the traveling of the vehicle 1. That is, controlling the steering means that the movement control device 12 controls at least one of a turning direction by steering, a vehicle speed or acceleration by accelerator steering, and deceleration or stop by brake steering.

The sensor device 14 is mounted on the vehicle 1 and acquires at least a situation outside the vehicle 1. Specifically, the sensor device 14 includes various sensors that detect a traveling state of the vehicle 1 and the situation outside the vehicle 1. The situation outside includes a video of an area outside the vehicle 1.

The sensor device 14 includes at least a camera 16. In addition, the sensor device 14 includes at least one of a light detection and ranging (LiDAR), a radar, a sonar, and an ultrasonic sensor. In addition, the sensor device 14 includes an accelerator pedal position sensor that detects an accelerator pedal position, a steering angle sensor that detects a steering angle of the steering device, a steering wheel rotation operation angle detection sensor that detects an angle of a steering wheel rotation operation of a steering wheel, an acceleration sensor that detects the acceleration applied during the acceleration and the deceleration of the vehicle 1, a torque sensor that detects a torque acting on the power transmission mechanism between the wheels of the vehicle 1 and the drive motor, a vehicle speed sensor that detects a vehicle speed of the vehicle 1, a wheel speed sensor, and the like.

The camera 16 is a surrounding sensor that is mounted on the vehicle 1 and monitors a surrounding environment of the vehicle 1. In the present embodiment, the camera 16 captures the surroundings of the vehicle 1 and outputs captured video data to the vehicle control device 10. Hereinafter, the captured video data may be simply referred to as a video. Furthermore, in the present embodiment, the camera 16 is also applied to an application of detecting an object present around the vehicle 1 and estimating a position where the vehicle 1 is present from a positional relationship between the vehicle 1 and the object present around the vehicle 1.

A position of the camera 16, the number of installed cameras, and a capturing direction of the camera are adjusted in advance such that the surroundings of the vehicle 1 can be captured.

FIG. 2 is a schematic diagram illustrating an example of disposition of the camera 16.

The vehicle 1 is provided with, for example, four cameras 16 so as to be able to acquire the situation outside the vehicle 1 in at least four directions of a first side S1, a second side S2, a front side S3, and a rear side S4 of the vehicle 1. The first side S1 is one side direction of the vehicle 1. The second side S2 is a side of the vehicle 1 that is opposite to the first side S1.

Specifically, for example, the camera 16 includes a first camera 16A, a second camera 16B, a third camera 16C, and a fourth camera 16D. The first camera 16A is disposed at a front portion of the vehicle 1 and captures an image of the front side S3 of the vehicle 1. The second camera 16B is disposed at a right portion of the vehicle 1 and captures an image of the first side S1 of the vehicle 1. The third camera 16C is disposed at a left portion of the vehicle 1 and captures an image of the second side S2 of the vehicle 1. The fourth camera 16D is disposed at a rear portion of the vehicle 1 and captures an image of the rear side S4 of the vehicle 1. The number of cameras 16 provided in the vehicle 1 is not limited to four. As for sensors that detect an object, such as the LiDAR, the radar, the sonar, and the ultrasonic sensor included in the sensor device 14, it is preferable that a disposition position, the number of disposed sensors, and the like are adjusted in advance such that the situation outside for each of the first side S1, the second side S2, the front side S3, and the rear side S4 of the vehicle 1 can be acquired.

Returning to FIG. 1, the description continues. The sensor device 14 outputs sensor information obtained by the detection to the vehicle control device 10. The sensor information includes a detection result of the sensor device 14 such as the LiDAR, the radar, the sonar, the ultrasonic sensor, the accelerator pedal position sensor, the steering angle sensor, the angle of the steering wheel rotation operation, the acceleration applied during the acceleration of the vehicle 1, the deceleration, the torque, the vehicle speed, or the like.

The storage device 18 stores various data. In the present embodiment, the storage device 18 stores data such as teaching path data 18A and map data 18B. Details of the teaching path data 18A and the map data 18B are described below. The storage device 18 is, for example, an auxiliary storage device such as a hard disk drive (HDD), a solid state drive (SSD), or a flash memory. At least part of the data included in the storage device 18 may be stored in an external storage device such as a server device provided outside the vehicle 1 and communicably connected to the vehicle control device 10.

The operation device 20 receives an operation by an occupant of the vehicle 1. The operation device 20 includes a steering device such as the steering wheel, an operation mechanism related to a driving operation such as an accelerator pedal, a brake pedal, a turn signal lever, and a push-button switch, and an input device such as a keyboard, a touch panel, or a switch. The operation device 20 may form a part of at least one of a human machine interface (HMI) and an in-vehicle infotainment (IVI).

The display device 22 is a display that outputs various images. The display device 22 is installed at a position visually recognizable by the occupant of the vehicle 1. Examples of the display include a liquid crystal display (LCD), an organic electro-luminescence (EL) display, and a projector. The display may also be a touch panel display in which the display device 22 and the operation device 20 are integrally configured. The display device 22 is an example of the HMI.

The vehicle control device 10 is an electronic control circuit that integrally controls the respective units of the vehicle 1. The vehicle control device 10 is mounted on the vehicle 1.

The vehicle control device 10 control the movement control device 12 such that the traveling state of the vehicle 1 is optimized by using the sensor information received from the sensor device 14. In addition, the vehicle control device 10 controls the movement control device 12 to cause the vehicle 1 to perform the autonomous travel.

The vehicle control device 10 includes a control circuit 11. A part of or the entire control circuit 11 may have a software configuration implemented by cooperation of a processor and various programs stored in a memory. In addition, a part of or the entire control circuit 11 may have a hardware configuration implemented by a dedicated circuit or the like.

The control circuit 11 integrally controls the respective units of the vehicle 1.

In the present embodiment, the control circuit 11 is configured to be able to switch a traveling mode to a teaching travel mode or an autonomous travel mode based on an input operation or the like of the operation device 20 by the occupant. The traveling mode executable by the vehicle 1 may include various traveling modes other than the teaching travel mode and the autonomous travel mode.

The teaching travel mode is a mode for registering a teaching path when causing the vehicle 1 to perform autonomous travel. The teaching path is a path obtained by performing teaching travel from a predetermined position to a target parking position. That is, the teaching path is an example of a parking path from the predetermined position to the target parking position.

In the teaching travel mode, the vehicle 1 is controlled to travel by an operation of the occupant. That is, in the teaching travel mode, the operation device 20 receives an operation, which is the driving operation by the occupant, and the control circuit 11 controls the movement control device 12 to perform traveling according to the operation. In other words, in the teaching travel mode, the control circuit 11 registers the teaching path based on the situation outside acquired by the sensor device 14 during the teaching travel in which the vehicle 1 travels from the predetermined position to the target parking position by the operation of the occupant.

The autonomous travel mode is a mode in which the vehicle 1 performs the autonomous travel. In the present embodiment, the autonomous travel mode means a mode in which the vehicle 1 performs the autonomous travel along the teaching path. In the autonomous travel mode, the control circuit 11 controls the movement control device 12 to control at least the acceleration and deceleration and the steering to perform traveling along the teaching path. In the autonomous travel mode, the vehicle 1 is automatically controlled to travel by the vehicle control device 10 without a manual operation by the occupant. That is, in the autonomous travel mode, the control circuit 11 causes the vehicle 1 to perform the autonomous travel by controlling at least the acceleration and deceleration and the steering from the predetermined position to the target parking position based on the situation outside acquired by the sensor device 14 based on the teaching path.

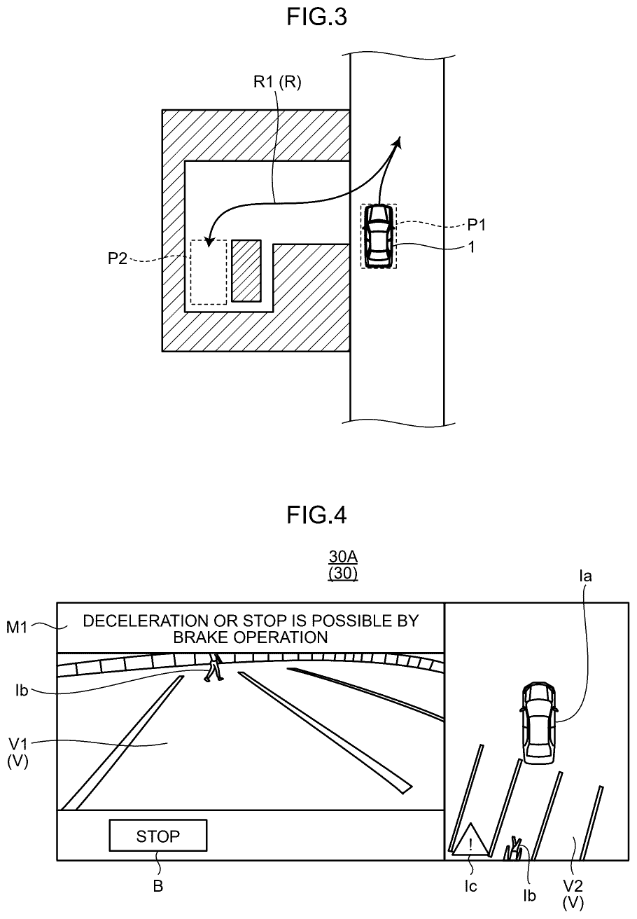

FIG. 3 is an explanatory diagram of an example of a teaching path R1.

In the teaching travel mode, the teaching travel from a predetermined position P1 to a target parking position P2 is performed by the manual operation of the operation device 20 by the occupant. The target parking position P2 is, for example, a parking lot or the like, but is not limited thereto. Further, it is sufficient if the predetermined position P1 is any position of the occupant in a real space.

The traveling path R along which the traveling has been performed by the teaching travel is treated as the teaching path R1. The teaching path data 18A of the teaching path R1 is stored in the storage device 18. During the teaching travel, for example, the occupant operates the operation device 20 such that traveling from the target parking position P2 toward the predetermined position P1 is performed. In a case where the vehicle 1 travels from the predetermined position P1 toward the target parking position P2 during the teaching travel, the control circuit 11 creates the teaching path data 18A of the teaching path R1 along a traveling direction of the traveling path R during the teaching travel.

In the autonomous travel mode, the control circuit 11 controls at least the acceleration and deceleration and the steering along the teaching path R1 obtained by the teaching travel, and causes the vehicle 1 to perform the autonomous travel from the predetermined position P1 to the target parking position P2 based on the teaching path R1 and the situation outside acquired by the sensor device 14 during the autonomous travel. In the autonomous travel mode, the control circuit 11 performs steering control and front and rear acceleration and deceleration control of the vehicle 1, and at least a part of the front and rear acceleration and deceleration control may be performed by an operation of a driver.

Next, control by the control circuit 11 in each of the teaching travel mode and the autonomous travel mode will be described in detail.

### Teaching Travel Mode

First, the control by the control circuit 11 in the teaching travel mode will be described in detail.

The control circuit 11 switches the traveling mode to the teaching travel mode when a signal indicating a start instruction for the teaching travel mode is received by an operation of the operation device 20 by the occupant. Then, the control circuit 11 executes the following processing in the teaching travel mode.

The control circuit 11 acquires the sensor information indicating the traveling state of the vehicle 1 from the sensor device 14. Then, the control circuit 11 estimates a current position of the vehicle 1 based on a temporal change of a sensor value indicated by the sensor information. For example, the control circuit 11 calculates a movement amount of the vehicle 1 from a reference position such as a traveling start position when the teaching travel mode is started based on a temporal change of the vehicle speed and a yaw rate represented by the sensor values, and estimates the current position of the vehicle 1 based on the movement amount.

Accuracy in estimation of the current position based on the movement amount may be low. Therefore, the control circuit 11 may use, as the current position, a result of correcting the estimated current position based on the video of the surroundings of the vehicle 1 acquired by the camera 16.

The control circuit 11 sequentially stores, in the storage device 18, the current positions of the vehicle 1 sequentially estimated during the traveling of the vehicle 1. Specifically, the control circuit 11 sets, as the teaching path R1, the traveling path R during the teaching travel represented by a group of the current positions sequentially estimated from a time point when the start instruction for the teaching travel mode is received to a time point when an end instruction for the teaching travel mode is received, and stores the teaching path data 18A representing the teaching path R1 in the storage device 18. In addition, the control circuit 11 stores the map data 18B in the storage device 18.

The teaching path data 18A includes a group of pieces of traveling information for each of positions which are the current positions sequentially estimated during the teaching travel. The traveling information includes an INDEX, a traveling position, an azimuth, a traveling direction, and reference traveling information. The INDEX is identification information of the traveling information. The traveling position is an estimated position of the vehicle 1. The azimuth indicates the orientation of the vehicle 1 at the position. The traveling direction indicates the traveling direction of the vehicle 1 at the position, and is represented by, for example, forward or backward. The reference traveling information is information indicating the traveling state or the like at the position. The reference traveling information is, for example, information such as the steering angle and the vehicle speed detected at each position during the teaching travel.

In addition, the control circuit 11 creates the map data 18B for estimating the current position of the vehicle 1 from the video captured by the camera 16 during the teaching travel of the vehicle 1. As a method for estimating the current position of the vehicle 1 from the video, a simultaneous localization and mapping (SLAM) method or the like is used.

The map data 18B is map data in which a plurality of first feature points around the vehicle 1 during the traveling along the teaching path R1 are registered.

The first feature point is a feature point obtained by analyzing the situation outside acquired by the sensor device 14 during the teaching travel such as the video captured by the camera 16 at the time of the teaching travel. That is, in the present embodiment, a feature point specified according to the situation outside acquired by the sensor device 14 during the teaching travel at the time of the teaching travel will be referred to as the first feature point.

For example, the feature point is a portion where a characteristic image pattern can be obtained by video analysis in an object (for example, a tree, a wall, or a column) included in a real view. The portion is, for example, an edge portion of the object. As described above, in the present embodiment, the feature point specified during the teaching travel will be referred to as the first feature point. Therefore, the map data 18B includes the plurality of first feature points, and each of the first feature points is identifiably registered for each first feature point by being assigned an identification number.

The feature point is indicated by feature point data including a three-dimensional position and a feature amount.

The three-dimensional position of the feature point is the three-dimensional position of the feature point in the real space, and is represented by, for example, a three-dimensional orthogonal coordinate system (X, Y, Z).

The feature amount of the feature point is a characteristic amount represented by the image analysis of the video of the feature point. The feature amount of the first feature point is, for example, a luminance and a density on the video, a scale invariant feature transform (SIFT) feature amount, a speeded up robust features (SURF) feature amount, or the like.

In the map data 18B, one first feature point is registered for each identical three-dimensional position. For the identical three-dimensional position, the plurality of first feature points may be registered in the map data 18B for each capturing position and capturing direction of the camera 16 at the three-dimensional position. In addition, the feature point data of the first feature point registered in the map data 18B may further include image data of the object having the first feature point.

At the time of the teaching travel, the control circuit 11 specifies coordinates of the first feature point in the real view from the situation outside acquired by the sensor device 14 during the teaching travel using, for example, stereo photogrammetry. Specifically, the control circuit 11 reads a plurality of captured images captured at different timings and forming the video included in the situation outside acquired by the sensor device 14 during the teaching travel, and associates the same first feature point commonly appearing in the plurality of captured images. Then, for example, the control circuit 11 estimates a temporary position of the vehicle 1 when the plurality of captured images are captured, and specifies temporary coordinates of the first feature point in the real view according to a principle of triangulation. Then, for example, the control circuit 11 performs bundle adjustment by using the temporary position of the vehicle 1 and the temporary coordinates of the first feature point in the real view as reference information, and calculates a formal position of the vehicle 1 and formal coordinates of the first feature point in the real view so as to minimize a reprojection error when each first feature point in the real view is projected on all the captured images. Then, the control circuit 11 stores, in the storage device 18, the map data 18B in which the first feature point indicated by the feature point data including the formal coordinates of the first feature point in the real view as the three-dimensional position is registered.

The three-dimensional position of the first feature point registered in the map data 18B may be a position measured in advance using the LiDAR or a stereo camera without using the SLAM method. However, from the viewpoint of suppressing a decrease in position estimation accuracy, it is preferable to use the SLAM method.

As described above, the control circuit 11 executes the above-described processing in the teaching travel mode. Therefore, in the teaching travel mode, the control circuit 11 registers the teaching path data 18A and the map data 18B in the storage device 18 based on the situation outside acquired by the sensor device 14 during the outside teaching travel acquired by the sensor device 14 at the time of the teaching travel. In other words, the control circuit 11 generates the teaching path data 18A of the teaching path R1 obtained by the teaching travel from the predetermined position P1 to the target parking position P2 and the map data 18B in which the three-dimensional position of each of the plurality of first feature points around the vehicle 1 during the traveling along the teaching path R1 and the feature amount of the first feature point are registered based on the situation outside acquired by the sensor device 14 during the teaching travel, and stores the generated pieces of data in the storage device 18. Therefore, the storage device 18 stores the teaching path data 18A including the group of pieces of traveling information for each of the positions that are the current positions sequentially estimated during the teaching travel, and the map data 18B in which the first feature point observed for each position is registered.

### Autonomous Travel Mode

Next, the control by the control circuit 11 in the autonomous travel mode will be described in detail.

The control circuit 11 switches the traveling mode to the autonomous travel mode when a signal indicating a start instruction for the autonomous travel mode is received by the operation of the operation device 20 by the occupant. Then, the control circuit 11 executes the following processing in the autonomous travel mode.

The control circuit 11 causes the vehicle 1 to perform the autonomous travel by controlling at least the acceleration and deceleration and the steering based on the situation outside acquired by the sensor device 14.

According to the present embodiment, the control circuit 11 reads the teaching path data 18A and the map data 18B from the storage device 18, and controls the movement control device 12 to perform the autonomous travel along the teaching path R1 indicated by the teaching path data 18A.

The control circuit 11 estimates the current position of the vehicle 1 based on the map data 18B and the video of the surroundings of the vehicle 1 acquired by at least one camera 16.

For example, the control circuit 11 collates a second feature point specified from the situation outside acquired by the sensor device 14 during the autonomous travel and including the video of the camera 16 with the first feature point specified from the situation outside acquired by the sensor device 14 during the teaching travel and stored in the map data 18B by using pattern matching, feature amount search, or the like.

The second feature point is a feature point obtained by analyzing a situation outside acquired by the sensor device 14 during autonomous travel such as a video captured by the camera 16 during autonomous travel along the teaching path R1. That is, in the present embodiment, a feature point specified according to the situation outside acquired by the sensor device 14 during the autonomous travel along the teaching path R1 will be referred to as the second feature point. It is sufficient if the control circuit 11 specifies the second feature point during the autonomous travel along the teaching path R1 by using a method similar to the method of specifying the first feature points during the teaching travel.

The control circuit 11 randomly selects several (for example, three to six) second feature points among the second feature points specified during the autonomous travel and collated with the first feature points stored in the map data 18B.

Then, the control circuit 11 estimates the current position of the vehicle 1 in the real space based on positions of the several second feature points in the video and the three-dimensional positions of the first feature points registered in the map data 18B corresponding to the several second feature points in the real space. At this time, the control circuit 11 estimates the current position of the vehicle 1 by solving a PnP problem using, for example, a known method such as Lambda Twist (for example, Literature: Mikael Persson et al. “Lambda Twist: An Accurate Fast Robust Perspective Three Point (P3P) Solver.”, ECCV 2018, pp 334-349, published in 2018, http://openaccess.thecvf.com/content ECCV 2018/papers/Mikael Persson Lambda Twist An ECCV 2018 paper.pdf).

Through these steps of processing, the control circuit 11 estimates, as current position information indicating the current position of the vehicle 1, current position information including information regarding a two-dimensional position (X coordinate, Y coordinate) of the vehicle 1 in the real space and a posture which is the orientation of the vehicle 1, based on the map data 18B and the video of the surroundings of the vehicle 1 acquired by at least one camera 16.

Then, the control circuit 11 causes the vehicle 1 to perform the autonomous travel from the predetermined position P1 toward the target parking position P2 along the teaching path R1 by controlling the movement control device 12 such that the estimated current position of the vehicle 1 is a position on the teaching path R1 indicated by the teaching path data 18A. Then, the control circuit 11 stops the vehicle 1 at the target parking position P2.

During the autonomous travel of the vehicle 1 along the teaching path R1, the control circuit 11 feedback-controls the movement control device 12 such that the vehicle 1 moves along the teaching path R1 based on the estimated current position of the vehicle 1 and each position on the teaching path R1 indicated by the teaching path data 18A.

Here, in the present embodiment, the control circuit 11 further determines whether or not the situation outside acquired by the sensor device 14 satisfies a first condition during the autonomous travel.

The first condition means that the situation outside acquired by the sensor device 14 during the autonomous travel is a situation in which it is necessary to decelerate or stop the vehicle 1. Specifically, the first condition indicates, for example, that an obstacle has been detected in the traveling direction of the vehicle 1.

The obstacle is an obstacle for the traveling of the vehicle 1. Specifically, for example, the obstacle is a person.

The control circuit 11 determines whether or not the first condition is satisfied by determining whether or not the situation outside acquired by the sensor device 14 during the autonomous travel is a situation in which it is necessary to decelerate or stop the vehicle 1. The present embodiment will be described assuming that the first condition means that the obstacle has been detected in the traveling direction of the vehicle 1. Therefore, in the present embodiment, the control circuit 11 determines whether or not the first condition is satisfied by determining whether or not the situation outside indicated by the sensor information indicates that the obstacle has been detected in the traveling direction of the vehicle 1. It is sufficient if the control circuit 11 determines whether or not the obstacle has been detected in the traveling direction of the vehicle 1 by analyzing the sensor information indicating the situation outside acquired by the sensor device 14 during the autonomous travel of the vehicle 1 by a known method.

At this time, the control circuit 11 derives a distance between the obstacle detected in the traveling direction of the vehicle 1 and the vehicle 1. It is sufficient if the control circuit 11 derives the distance between the vehicle 1 and the obstacle by analyzing a detection result of the sensor device 14 such as the LiDAR, the radar, the sonar, or the ultrasonic sensor included in the sensor information by a known method.

In a case where it is determined that the situation outside acquired by the sensor device 14 satisfies the first condition during the autonomous travel, the control circuit 11 displays on the display device 22 that at least one of the deceleration and the stop is possible by a brake operation. In a case where the operation device 20 has received a second operation that is the brake operation, the control circuit 11 deactivates the autonomous travel, and displays on the display device 22 that the autonomous travel has been interrupted.

Specifically, in a case where it is determined that the situation outside acquired by the sensor device 14 satisfies the first condition during the autonomous travel, the control circuit 11 displays on the display device 22 that at least one of the deceleration and the stop is possible by the brake operation.

FIG. 4 is a schematic diagram of an example of a first screen 30A. The first screen 30A is an example of a screen 30 displayed on the display device 22.

In a case where it is determined that the situation outside acquired by the sensor device 14 satisfies the first condition during the autonomous travel, the control circuit 11 displays on the display device 22 the first screen 30A indicating that at least one of the deceleration and the stop is possible by the brake operation. FIG. 4 illustrates, as an example, a scene in which the obstacle has been detected in the traveling direction of the vehicle as the first condition. FIG. 4 illustrates an example in which the obstacle is a person.

The first screen 30A includes at least a first indicator M1. The first indicator M1 is an indicator indicating that at least one of the deceleration and the stop is possible by the brake operation. FIG. 4 illustrates, as an example, a mode in which the first indicator M1 is a text indicating that at least one of the deceleration and the stop is possible by the brake operation. The first indicator M1 may be a still image, an animation image, an icon, or the like indicating that at least one of the deceleration and the stop is possible by the brake operation, and is not limited to the text.

In addition, the first screen 30A may further include a video V captured by the camera 16. FIG. 4 illustrates a mode in which the first screen 30A includes a video V1 and a video V2 as the videos V. The video V1 is the video V in the traveling direction of the vehicle 1. The video V2 is a video of a top view of the vehicle 1. The top view is a bird's-eye view image as if the vehicle 1 is viewed from above. In the scene illustrated in FIG. 4, a person Ib, which is an example of the obstacle positioned in the traveling direction of the vehicle 1, is included in the video V1 and the video V2. It is sufficient if the control circuit 11 generates and display the video V2 by combining the videos V captured by the cameras 16 by a known method. Furthermore, the control circuit 11 may dispose and display an image Ia schematically representing the vehicle 1 at a position corresponding to the current position of the vehicle 1 in the video V2. Furthermore, the control circuit 11 may further dispose and display an image Ic for calling attention to the obstacle.

The first screen 30A may further include a stop button image B for receiving a traveling stop instruction from the occupant.

In a case where it is determined that the situation outside acquired by the sensor device 14 satisfies the first condition during the autonomous travel, the control circuit 11 displays the first screen 30A on the display device 22, so that the control circuit 11 can provide, to the occupant, visible information that at least one of the deceleration and the stop is possible by the brake operation.

Then, the control circuit 11 determines whether or not the operation device 20 has received the second operation that is the brake operation. The control circuit 11 determines whether or not the brake operation in which the brake pedal included in the operation device 20 is pressed by the occupant has been performed, thereby determining whether or not the operation device 20 has received the second operation.

It is preferable that the control circuit 11 determines whether or not the second operation is received within a predetermined time after the first screen 30A including the first indicator M1 is displayed on the display device 22. It is sufficient if the predetermined time is set in advance. Furthermore, the predetermined time may be changeable as appropriate according to an operation instruction of the operation device 20 by the occupant or the like or the like.

When it is determined that the second operation has been received within the predetermined time after the first screen 30A including the first indicator M1 is displayed on the display device 22, the control circuit 11 deactivates the autonomous travel and displays on the display device 22 that the autonomous travel has been interrupted.

For example, the control circuit 11 deactivates the autonomous travel by switching the autonomous travel mode to a normal traveling mode in which the vehicle 1 travels according to the manual operation of the occupant. Then, the control circuit 11 displays on the display device 22 that the autonomous travel has been interrupted.

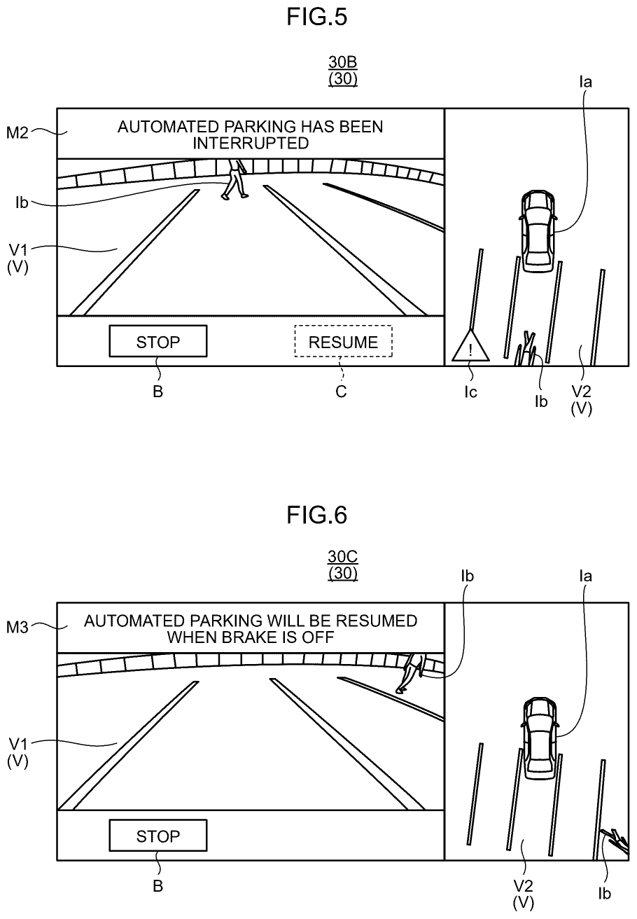

FIG. 5 is a schematic diagram of an example of a second screen 30B. The second screen 30B is an example of the screen 30 displayed on the display device 22. Similarly to FIG. 4, FIG. 5 illustrates, as an example, a scene in which the obstacle has been detected in the traveling direction of the vehicle 1 as the first condition. FIG. 5 illustrates an example in which the obstacle is a person.

The control circuit 11 determines that the situation outside acquired by the sensor device 14 satisfies the first condition during the autonomous travel, displays the first screen 30A on the display device 22, and displays the second screen 30B on the display device 22 when the operation device 20 receives the second operation that is the brake operation to deactivate the autonomous travel.

The second screen 30B includes at least a second indicator M2. The second indicator M2 is an indicator indicating that the autonomous travel has been interrupted. FIG. 5 illustrates, as an example, a mode in which the second indicator M2 is a text indicating that the autonomous travel has been interrupted. The second indicator M2 may be a still image, an animation image, an icon, or the like indicating that the autonomous travel has been interrupted, and is not limited to the text.

In addition, the second screen 30B may further include a video V captured by the camera 16. FIG. 5 illustrates a mode in which the second screen 30B includes a video V1 and a video V2 as the videos V. Definitions of the video V1 and the video V2 are the same as described above. In the scene illustrated in FIG. 5, a person Ib, which is an example of the obstacle positioned in the traveling direction of the vehicle 1, is included in the video V1 and the video V2. Furthermore, the control circuit 11 may dispose and display an image Ia schematically representing the vehicle 1 at a position corresponding to the current position of the vehicle 1 in the video V2. The second screen 30B may further include a stop button image B for receiving a traveling stop instruction from the occupant. Furthermore, a resume button C for receiving a resumption instruction for the autonomous travel may be displayed on the second screen 30B in a form that cannot be selected by the user. The resume button C is a button image region in a form in which an operation instruction of the user is not received at least during a period in which the obstacle exists in the traveling direction of the vehicle 1.

By the control circuit 11 displaying the second screen 30B on the display device 22, the control circuit 11 can provide, to the occupant, visible information that the autonomous travel has been interrupted.

Returning to FIG. 1, the description continues.

In a case where it is determined that the vehicle 1 has been stopped by the second operation after deactivating the autonomous travel and the situation outside acquired by the sensor device 14 satisfies a second condition, the control circuit 11 displays on the display device 22 that the autonomous travel will be resumed when the brake operation is released. Then, in a case where the operation device 20 has received a third operation of releasing the brake operation, the control circuit 11 resumes the autonomous travel.

Specifically, in a case where it is determined that the vehicle 1 has stopped by the second operation after the autonomous travel is deactivated, the control circuit 11 determines whether or not the situation outside acquired by the sensor device 14 satisfies the second condition.

The control circuit 11 determines whether or not the vehicle 1 has stopped by the second operation by determining that the operation device 20 has received the second operation that is the brake operation and determining whether or not the vehicle speed included in the sensor information is a vehicle speed (for example, zero) indicating that the vehicle 1 is stopped. When it is determined that the vehicle 1 has stopped by the second operation, the control circuit 11 determines whether or not the situation outside acquired by the sensor device 14 satisfies the second condition.

The second condition means that the situation outside acquired by the sensor device 14 indicates a situation in which autonomous travel of the vehicle 1 is available. Specifically, the second condition indicates that, for example, the obstacle detected in the traveling direction of the vehicle 1 has been no longer detected.

When it is determined that the vehicle 1 has stopped by the second operation, the control circuit 11 analyzes the sensor information indicating the situation outside acquired by the sensor device 14 and the traveling direction of the vehicle 1 by a known method to determine whether or not the obstacle detected in the traveling direction of the vehicle 1 has been no longer detected.

Then, in a case where it is determined that the situation outside acquired by the sensor device 14 satisfies the second condition, the control circuit 11 displays on the display device 22 that the autonomous travel will be resumed when the brake operation is released.

FIG. 6 is a schematic diagram of an example of a third screen 30C. The third screen 30C is an example of the screen 30 displayed on the display device 22.

In a case where it is determined that the vehicle has stopped by the second operation after the autonomous travel is deactivated and the situation outside acquired by the sensor device 14 satisfies the second condition, the control circuit 11 displays the third screen 30C on the display device 22. FIG. 6 illustrates, as an example, a scene in which the obstacle is no longer detected in the traveling direction of the vehicle 1 as the second condition. FIG. 6 illustrates an example in which the obstacle is a person.

The third screen 30C includes at least a third indicator M3. The third indicator M3 is an indicator indicating that the autonomous travel will be resumed when the brake operation is released. FIG. 6 illustrates, as an example, a mode in which the third indicator M3 is a text indicating that the autonomous travel will be resumed when the brake operation is released. The third indicator M3 may be a still image, an animation image, an icon, or the like indicating that the autonomous travel will be resumed when the brake operation is released, and is not limited to the text.

In addition, the third screen 30C may further include a video V captured by the camera 16. FIG. 6 illustrates a mode in which the third screen 30C includes a video V1 and a video V2 as the videos V. Definitions of the video V1 and the video V2 are the same as described above. In the scene illustrated in FIG. 6, in the video V1 and the video V2, a person Ib, which is an example of the obstacle, appears at a position deviated from the traveling direction of the vehicle 1, and the obstacle is no longer detected in the traveling direction of the vehicle 1. Furthermore, the control circuit 11 may dispose and display an image Ia schematically representing the vehicle 1 at a position corresponding to the current position of the vehicle 1 in the video V2. The third screen 30C may further include a stop button image B for receiving a traveling stop instruction from the occupant.

By the control circuit 11 displaying the third screen 30C on the display device 22, the control circuit 11 can provide, to the occupant, visible information that the autonomous travel will be resumed when the occupant releases the brake operation as a method of resuming the autonomous travel of the vehicle 1 that has been deactivated when the operation device 20 has received the second operation that is the brake operation.

Returning to FIG. 1, the description continues.

Then, the control circuit 11 determines whether or not the operation device 20 has received the third operation of releasing the brake operation. It is sufficient if the control circuit 11 determines whether or not the operation device 20 has received the third operation by determining whether or not a state in which the brake pedal included in the operation device 20 is pressed by the occupant has been released. Then, in a case where it is determined that the operation device 20 has received the third operation of releasing the brake operation, the control circuit 11 resumes the autonomous travel.

It is sufficient if the control circuit 11 resumes the autonomous travel in which the vehicle 1 autonomously travels by controlling at least the acceleration and deceleration and the steering along the teaching path R1 based on the situation outside acquired by the sensor device 14, by switching the mode to the autonomous travel mode.

In a case where it is determined that the situation outside acquired by the sensor device 14 satisfies the first condition during the autonomous travel, the control circuit 11 decelerates the vehicle 1 at a predetermined deceleration to stop the vehicle 1, deactivates the autonomous travel, and displays on the display device 22 that the autonomous travel has been interrupted.

Specifically, in a case where it is determined that the situation outside acquired by the sensor device 14 satisfies the first condition, the control circuit 11 displays on the display device 22 the first screen 30A including the first indicator M1 indicating that at least one of the deceleration and the stop is possible by the brake operation as described above (FIG. 4). Then, in a case where it is determined that the second operation has not been received within the predetermined time after the first screen 30A including the first indicator M1 is displayed on the display device 22, the control circuit 11 decelerates the vehicle 1 at the predetermined deceleration and stops the vehicle 1.

In this case, the control circuit 11 controls the movement control device 12 to decelerate and stop the vehicle 1 at the predetermined deceleration. It is sufficient if the predetermined deceleration is determined in advance. The predetermined deceleration may be changeable according to the operation instruction of the operation device 20 by the occupant or the like.

In the present embodiment, in a case where the sensor device 14 has detected the obstacle a first distance away in the traveling direction of the vehicle 1 during the autonomous travel, the control circuit 11 decelerates and stops the vehicle 1 at a first deceleration. In addition, in a case where the sensor device 14 has detected the obstacle a second distance away in the traveling direction of the vehicle 1 during the autonomous travel, the second distance being shorter than the first distance, the control circuit 11 decelerates and stops the vehicle 1 at a second deceleration greater than the first deceleration.

It is sufficient if the first distance is in a range of a distance shorter than the second distance. It is sufficient if the second distance is a range of distances equal to or longer than the first distance. It is sufficient if information indicating a distance range representing each of the first distance and the second distance is set in advance and stored in the storage device 18 in advance. In addition, the information indicating the range representing each of the first distance and the second distance may be changeable as appropriate so as to satisfy the above condition by the operation instruction of the operation device 20 by the occupant or the like.

The control circuit 11 specifies whether or not a distance between the obstacle and the vehicle 1 derived when the obstacle has been detected in the traveling direction of the vehicle 1 is the first distance or the second distance. Then, in a case where the specified distance is the first distance, the control circuit 11 decelerates the vehicle 1 at the first deceleration and stops the vehicle 1. In a case where the specified distance is the second distance, the control circuit 11 decelerates the vehicle 1 at the second deceleration and stops the vehicle 1.

Then, the control circuit 11 deactivates the autonomous travel. Similarly to the above, the control circuit 11 deactivates the autonomous travel by switching the autonomous travel mode to the normal traveling mode in which the vehicle 1 travels according to the manual operation of the occupant. Then, the control circuit 11 displays on the display device 22 that the autonomous travel has been interrupted.

For example, the control circuit 11 displays on the display device 22 the above-described second screen 30B illustrated in FIG. 5. That is, when it is determined that the situation outside acquired by the sensor device 14 satisfies the first condition during the autonomous travel, the control circuit 11 displays on the display device 22 the first screen 30A illustrated in FIG. 4, decelerates the vehicle 1 at the first deceleration and stops the vehicle 1, and deactivates the autonomous travel, the control circuit 11 displays on the display device 22 the second screen 30B illustrated in FIG. 5.

By the control circuit 11 displaying the second screen 30B on the display device 22, the control circuit 11 can provide, to the occupant, visible information that the autonomous travel has been interrupted.

Returning to FIG. 1, the description continues.

When the control circuit 11 decelerates the vehicle 1 at the predetermined deceleration and stops the vehicle 1, deactivates the autonomous travel, and displays the second screen 30B on the display device 22, it is determined whether or not the situation outside acquired by the sensor device 14 satisfies the second condition.

It is sufficient if the control circuit 11 determines whether or not the second condition is satisfied in the same manner as described above. In a case where it is determined that the second condition is satisfied, the control circuit 11 displays on the display device 22 that the autonomous travel will be resumed when the brake operation is released after the brake operation.

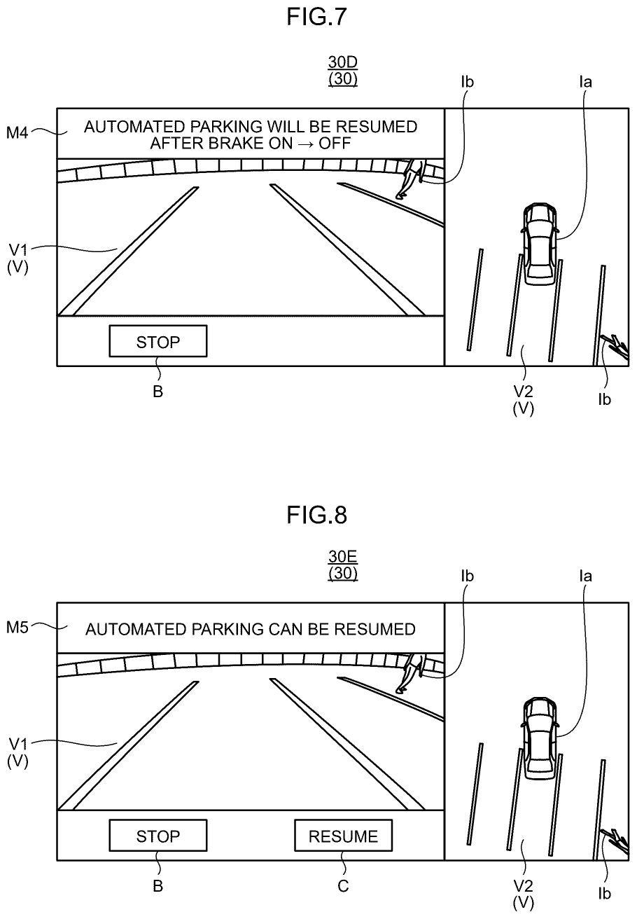

FIG. 7 is a schematic diagram of an example of a fourth screen 30D. The fourth screen 30D is an example of the screen 30 displayed on the display device 22.

In a case where it is determined that the situation outside acquired by the sensor device 14 satisfies the second condition after decelerating the vehicle 1 at the predetermined deceleration and stopping the vehicle 1 and deactivating the autonomous travel, the control circuit 11 displays the fourth screen 30D on the display device 22. FIG. 7 illustrates, as an example, a scene in which the obstacle is no longer detected in the traveling direction of the vehicle 1 as the second condition. FIG. 7 illustrates an example in which the obstacle is a person.

The fourth screen 30D includes at least a fourth indicator M4. The fourth indicator M4 is an indicator indicating that the autonomous travel will be resumed when the brake operation is released after the brake operation. FIG. 7 illustrates, as an example, a mode in which the fourth indicator M4 is a text indicating that the autonomous travel will be resumed when the brake operation is released after the brake operation. The fourth indicator M4 may be a still image, an animation image, an icon, or the like indicating that the autonomous travel will be resumed when the brake operation is released after the brake operation, and is not limited to the text.

The fourth screen 30D may further include a video V captured by the camera 16. FIG. 7 illustrates a mode in which the fourth screen 30D includes a video V1 and a video V2 as the videos V. Definitions of the video V1 and the video V2 are the same as described above. In the scene illustrated in FIG. 7, in the video V1 and the video V2, a person Ib, which is an example of the obstacle, appears at a position deviated from the traveling direction of the vehicle 1, and the obstacle is no longer detected in the traveling direction of the vehicle 1. Furthermore, the control circuit 11 may dispose and display an image Ia schematically representing the vehicle 1 at a position corresponding to the current position of the vehicle 1 in the video V2. The fourth screen 30D may further include a stop button image B for receiving a traveling stop instruction from the occupant.

By the control circuit 11 displaying the fourth screen 30D on the display device 22, the control circuit 11 can provide, to the occupant, visible information that the autonomous travel will be resumed when the occupant releases the brake operation after the brake operation as a method of resuming the autonomous travel of the vehicle 1 which has been decelerated at the predetermined deceleration and stopped in response to the detection of the obstacle and of which the autonomous travel has been deactivated.

The control circuit 11 may display the fourth screen 30D on the display device 22 after displaying a fifth screen on the display device 22 before displaying the fourth screen 30D.

FIG. 8 is a schematic diagram of an example of the fifth screen 30E. The fifth screen 30E is an example of the screen 30.

The fifth screen 30E includes at least a fifth indicator M5. The fifth indicator M5 is an indicator indicating that the autonomous travel can be resumed. FIG. 8 illustrates, as an example, a mode in which the fifth indicator M5 is a text indicating that the autonomous travel can be resumed. The fifth indicator M5 may be a still image, an animation image, an icon, or the like indicating that the autonomous travel can be resumed, and is not limited to the text.

The fifth screen 30E may further include a video V captured by the camera 16. FIG. 8 illustrates a mode in which the fifth screen 30E includes a video V1 and a video V2 as the videos V. Definitions of the video V1 and the video V2 are the same as described above. In the scene illustrated in FIG. 8, in the video V1 and the video V2, a person Ib, which is an example of the obstacle, appears at a position deviated from the traveling direction of the vehicle 1, and the obstacle is no longer detected in the traveling direction of the vehicle 1. Furthermore, the control circuit 11 may dispose and display an image Ia schematically representing the vehicle 1 at a position corresponding to the current position of the vehicle 1 in the video V2. The fifth screen 30E may further include a stop button image B for receiving a traveling stop instruction from the occupant, and a resume button C for receiving a resumption instruction for the autonomous travel. The fifth screen 30E does not have to include the resume button C for receiving the resumption instruction for the autonomous travel. That is, an operation instruction of the resume button C by a user is not an essential operation.

In a case where it is determined that the situation outside acquired by the sensor device 14 satisfies the second condition after decelerating the vehicle 1 at the predetermined deceleration and stopping the vehicle 1 and deactivating the autonomous travel, the control circuit 11 may display the fifth screen 30E on the display device 22 and then display the fourth screen 30D on the display device 22.

Returning to FIG. 1, the description continues.

Then, the control circuit 11 determines whether the operation device 20 has received the first operation of releasing the brake operation after the brake operation. It is sufficient if the control circuit 11 determines, after the brake pedal included in the operation device 20 is pressed by the occupant, whether or not the pressing operation has been released to determine whether or not the operation device 20 has received the first operation. Then, in a case where it is determined that the operation device 20 has received the first operation of releasing the brake operation after the brake operation, the control circuit 11 resumes the autonomous travel.

It is sufficient if the control circuit 11 resumes the autonomous travel by causing the vehicle 1 to perform the autonomous travel by controlling at least the acceleration and deceleration and the steering along the teaching path R1 based on the situation outside acquired by the sensor device 14, by switching the mode to the autonomous travel mode.

Next, an example of a flow of information processing executed by the control circuit 11 of the vehicle control device 10 will be described.

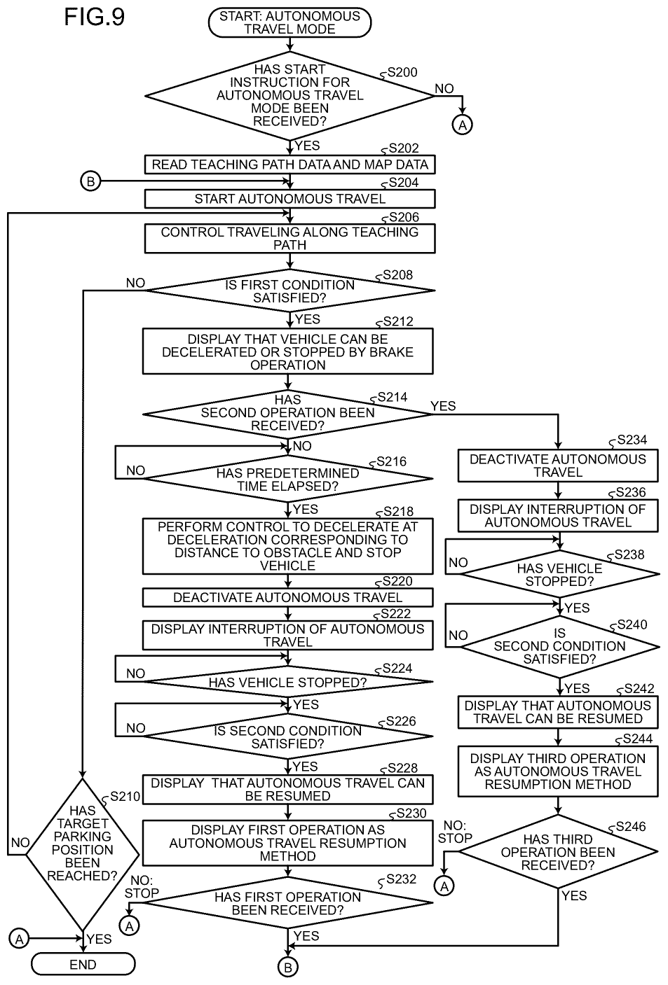

FIG. 9 is a flowchart illustrating an example of a flow of information processing executed by the control circuit 11 in the autonomous travel mode.

The control circuit 11 determines whether or not a signal indicating the start instruction for the autonomous travel mode has been received from the operation device 20 (step S200). When a negative determination is made in step S200 (step S200: No), this routine ends. When an affirmative determination is made in step S200 (step S200: Yes), the processing proceeds to step S202.

In step S202, the control circuit 11 reads the teaching path data 18A and the map data 18B from the storage device 18 (step S202). Then, the control circuit 11 starts the autonomous travel along the teaching path R1 indicated by the teaching path data 18A (step S204).

The control circuit 11 controls the movement control device 12 to perform the autonomous travel along the teaching path R1 indicated by the teaching path data 18A read in step S202 (step S206). That is, the control circuit 11 causes the vehicle 1 to perform the autonomous travel from the predetermined position P1 toward the target parking position P2 along the teaching path R1 by controlling the movement control device 12 such that the current position of the vehicle 1 included in the sensor information, which is the situation outside acquired by the sensor device 14 during the autonomous travel acquired from the sensor device 14, is a position on the teaching path R1 indicated by the teaching path data 18A.

The control circuit 11 determines whether or not the situation outside acquired by the sensor device 14 satisfies the first condition (step S208). In the present embodiment, the control circuit 11 determines whether or not the obstacle has been detected in the traveling direction of the vehicle 1, thereby making the determination of step S208.

When a negative determination is made in step S208 (step S208: No), the processing proceeds to step S210. In step S210, the control circuit 11 determines whether or not the vehicle 1 has reached the target parking position P2 (step S210). When an affirmative determination is made in step S210 (step S210: Yes), this routine ends. When a negative determination is made in step S210 (step S210: No), the processing returns to step S206.

On the other hand, when it is determined in step S208 that the first condition is satisfied (step S208: Yes), the processing proceeds to step S212.

In step S212, the control circuit 11 displays on the display device 22 that at least one of the deceleration and the stop is possible by the brake operation (step S212). By the processing of step S212, for example, the first screen 30A illustrated in FIG. 4 is displayed on the display device 22.

Next, the control circuit 11 determines whether or not the operation device 20 has received the second operation that is the brake operation (step S214). When a negative determination is made in step S214 (step S214: No), the control circuit 11 proceeds to step S216. In step S216, the control circuit 11 determines whether or not the predetermined time has elapsed after the first screen 30A including the first indicator M1 is displayed on the display device 22 in step S212 (step S216). A negative determination (step S216: No) is repeated until an affirmative determination is made in step S216. When an affirmative determination is made in step S216 (step S216: Yes), the processing proceeds to step S218.

In step S218, the control circuit 11 performs control to decelerate the vehicle 1 at the predetermined deceleration and stop the vehicle 1 (step S218). In a case where the distance between the obstacle detected in the traveling direction of the vehicle 1 in step S208 and the vehicle 1 is the first distance, the control circuit 11 decelerates the vehicle 1 at the first deceleration and stops the vehicle 1. In a case where the distance between the obstacle detected in the traveling direction of the vehicle 1 in step S208 and the vehicle 1 is the second distance shorter than the first distance, the control circuit 11 decelerates the vehicle 1 at the second deceleration greater than the first deceleration and stops the vehicle 1.

The control circuit 11 deactivates the autonomous travel (step S220). The control circuit 11 deactivates the autonomous travel by switching the autonomous travel mode to a normal traveling mode in which the vehicle 1 travels according to the manual operation of the occupant. Then, the control circuit 11 displays on the display device 22 that the autonomous travel has been interrupted (step S222). By the processing of step S222, for example, the second screen 30B illustrated in FIG. 5 is displayed on the display device 22.

Next, the control circuit 11 determines whether or not the vehicle 1 has stopped (step S224). The control circuit 11 determines whether or not the vehicle speed of the vehicle 1 indicated by the sensor information has become zero and position movement has been stopped, thereby making the determination of step S224. The control circuit 11 repeats a negative determination (step S224: No) until an affirmative determination is made in step S224 (step S224: Yes). When an affirmative determination is made in step S224 (step S224: Yes), the control circuit 11 proceeds to step S226.

The control circuit 11 determines whether or not the situation outside acquired by the sensor device 14 satisfies the second condition (step S226). The control circuit 11 determines whether or not the obstacle detected in the traveling direction of the vehicle 1 has been no longer detected, thereby making the determination of step S226. The control circuit 11 repeats a negative determination (step S226: No) until an affirmative determination is made in step S226 (step S226: Yes). When an affirmative determination is made in step S224 (step S226: Yes), the control circuit 11 proceeds to step S228.

In step S228, the control circuit 11 displays on the display device 22 that autonomous travel can be resumed (step S228). By the processing of step S228, for example, the fifth screen 30E illustrated in FIG. 8 is displayed on the display device 22.

Next, the control circuit 11 displays on the display device 22 that the autonomous travel will be resumed when the brake operation is released after the brake operation (step S230). By the processing of step S226, for example, the fourth screen 30D illustrated in FIG. 7 is displayed on the display device 22. That is, the control circuit 11 displays on the display device 22 the first operation of releasing the brake operation after the brake operation as an autonomous travel resumption method.

Next, the control circuit 11 determines whether or not the operation device 20 has received the first operation of releasing the brake operation after the brake operation (step S232). When an affirmative determination is made in step S232 (step S232: Yes), the control circuit 11 switches the mode to the autonomous travel mode, returns to step S204, and resumes the autonomous travel. When a negative determination is made in step S230 (step S232: No), the control circuit 11 ends this routine.

On the other hand, in a case where it is determined in step S214 that the second operation has been received within the predetermined time (step S214: Yes), the control circuit 11 proceeds to step S234.

In step S234, the control circuit 11 deactivates the autonomous travel (step S234). For example, the control circuit 11 deactivates the autonomous travel by switching the autonomous travel mode to a normal traveling mode in which the vehicle 1 travels according to the manual operation of the occupant. Then, the control circuit 11 displays on the display device 22 that the autonomous travel has been interrupted (step S236). By the processing of step S236, for example, the second screen 30B illustrated in FIG. 5 is displayed on the display device 22.

Next, the control circuit 11 determines whether or not the vehicle 1 has stopped (step S238). The control circuit 11 performs the determination of step S238 in the same manner as in step S224. The control circuit 11 repeats a negative determination (step S238: No) until an affirmative determination is made in step S238 (step S238: Yes). When an affirmative determination is made in step S238 (step S238: Yes), the control circuit 11 proceeds to step S240.

Next, the control circuit 11 determines whether or not the situation outside acquired by the sensor device 14 satisfies the second condition (step S240). The control circuit 11 performs the determination of step S240 by determining whether or not the obstacle detected in the traveling direction of the vehicle 1 has been no longer detected.

The control circuit 11 repeats a negative determination until an affirmative determination is made in step S240 (step S240: Yes) (step S240: No). When an affirmative determination is made in step S240 (step S240: Yes), the processing proceeds to step S242.

In step S242, the control circuit 11 displays on the display device 22 that autonomous travel can be resumed (step S242). By the processing of step S242, for example, the fifth screen 30E illustrated in FIG. 8 is displayed on the display device 22.

Next, the control circuit 11 displays on the display device 22 that the autonomous travel will be resumed when the brake operation is released (step S244). By the processing of step S244, for example, the third screen 30C illustrated in FIG. 6 is displayed on the display device 22. That is, the control circuit 11 displays on the display device 22 the third operation that is the release of the brake operation as the autonomous travel resumption method.

Next, the control circuit 11 determines whether or not the operation device 20 has received the third operation of releasing the brake operation (step S246). When an affirmative determination is made in step S246 (step S246: Yes), the control circuit 11 switches the mode to the autonomous travel mode, returns to step S204, and resumes the autonomous travel. When a negative determination is made in step S246 (step S246: No), the control circuit 11 ends this routine.

As described above, the vehicle control device 10 according to the present embodiment is a vehicle control method executed by the vehicle control device 10 mounted on the vehicle 1 including the operation device 20 that receives the operation of the occupant, the sensor device 14 that acquires the situation outside, the display device 22 that is visually recognizable by the occupant, and the movement control device 12 that controls at least the acceleration and deceleration and the steering. The control circuit 11 of the vehicle control device 10 controls at least the acceleration and deceleration and the steering based on the situation outside acquired by the sensor device 14 to cause the vehicle 1 to perform the autonomous travel. When it is determined that the situation outside acquired by the sensor device 14 satisfies the first condition during the autonomous travel, the control circuit 11 decelerates the vehicle 1 at the predetermined deceleration and stops the vehicle 1, deactivates the autonomous travel, and displays on the display device 22 that the autonomous travel has been interrupted. When it is determined that the situation outside acquired by the sensor device 14 satisfies the second condition after deactivating the autonomous travel, the control circuit 11 displays on the display device 22 that the autonomous travel will be resumed when the brake operation is released after the brake operation. In a case where the operation device 20 has received the first operation of releasing the brake operation after the brake operation, the control circuit 11 resumes the autonomous travel.

As described above, in a case where it is determined that the situation outside satisfies the first condition during the autonomous travel, the control circuit 11 of the vehicle control device 10 according to the present embodiment decelerates and stops the vehicle 1, deactivates the autonomous travel, and displays on the display device 22 that the autonomous travel has been interrupted. Then, in a case where the situation outside satisfies the second condition after releasing the autonomous travel, the control circuit 11 displays on the display device 22 the first operation of releasing the brake operation after the brake operation as the autonomous travel resumption method, and resumes the autonomous travel in a case where the first operation has been received.

Therefore, the control circuit 11 of the vehicle control device 10 according to the present embodiment can display, on the display device 22, the autonomous travel resumption method according to a method of stopping the vehicle 1 when the autonomous travel is deactivated.

Therefore, the control circuit 11 of the vehicle control device 10 according to the present embodiment can provide more suitable resumption control for the autonomous travel.

Next, a hardware configuration of the vehicle control device 10 according to the present embodiment will be described.

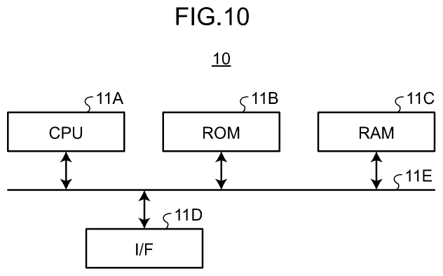

FIG. 10 is a block diagram illustrating a hardware configuration example of the vehicle control device 10.

The vehicle control device 10 has a hardware configuration using a normal computer in which a central processing unit (CPU) 11A, a read only memory (ROM) 11B, a random access memory (RAM) 11C, an interface (I/F) 11D for connecting to various devices, and the like are connected to one another by a bus 11E.

The CPU 11A is an arithmetic device that controls the entire processing of the vehicle control device 10. The RAM 11C stores data necessary for various types of processing executed by the CPU 11A. The ROM 11B stores a program or the like that implements various types of processing executed by the CPU 11A. The I/F 11D is an interface that is connected to an external device or an external terminal via a communication line or the like and transmits and receives data to and from the connected external device or external terminal.

A program for executing the above-described various types of processing executed by the vehicle control device 10 is provided by being incorporated in the ROM 11B or the like in advance. A program for executing the vehicle control method executed in the present embodiment may be provided by being recorded in a computer-readable recording medium such as a CD-ROM, a flexible disk (FD), a CD-R, or a digital versatile disc (DVD) as a file in a format installable or executable in these devices.

In addition, the program for executing the vehicle control method executed in the present embodiment may be stored on a computer connected to a network such as the Internet and provided by being downloaded via the network. In addition, the program for executing the vehicle control method executed in the present embodiment may be provided or distributed via a network such as the Internet.

With the vehicle control method and the vehicle control device according to the present disclosure, it is possible to provide more suitable resumption control for autonomous travel.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method executed by a vehicle control device mounted on a vehicle including an operation device that receives an operation of an occupant, a sensor device that acquires a situation outside, a display device that is visually recognizable by the occupant, and a movement control device that controls at least acceleration and deceleration and steering, the vehicle control method comprising:
causing the vehicle to perform autonomous travel by controlling at least the acceleration and deceleration and the steering based on the situation outside acquired by the sensor device;
decelerating the vehicle at a predetermined deceleration and stopping the vehicle, deactivating the autonomous travel, and displaying on the display device that the autonomous travel has been interrupted, when determining that the situation outside acquired by the sensor device satisfies a first condition during the autonomous travel; and
displaying on the display device that the autonomous travel will be resumed when a brake operation is released after the brake operation when determining that the situation outside acquired by the sensor device satisfies a second condition after deactivating the autonomous travel, and resuming the autonomous travel in a case where the operation device receives a first operation of releasing the brake operation after the brake operation.

2. The vehicle control method according to claim 1, wherein
the first condition is that an obstacle has been detected in a traveling direction of the vehicle, and
the second condition is that the obstacle detected in the traveling direction of the vehicle has been no longer detected.

3. The vehicle control method according to claim 2, wherein the obstacle is a person.

4. The vehicle control method according to claim 2, wherein
in a case where the sensor device detects the obstacle a first distance away in the traveling direction of the vehicle during the autonomous travel, the vehicle is decelerated at a first deceleration and stopped, the autonomous travel is deactivated, and it is displayed on the display device that the autonomous travel has been interrupted, and
in a case where the sensor device no longer detects the obstacle after deactivating the autonomous travel, it is displayed on the display device that the autonomous travel will be resumed when the brake operation is released after the brake operation, and the autonomous travel is resumed in a case where the operation device receives the first operation.

5. The vehicle control method according to claim 4, wherein
the vehicle is decelerated at a second deceleration greater than the first deceleration and stopped in a case where the sensor device detects the obstacle a second distance away in the traveling direction of the vehicle during the autonomous travel, the second distance being shorter than the first distance.

6. The vehicle control method according to claim 1, wherein
in a case where it is determined that the situation outside acquired by the sensor device satisfies the second condition after deactivating the autonomous travel, it is displayed on the display device that the autonomous travel is available, it is displayed on the display device that the autonomous travel will be resumed when the brake operation is released after the brake operation, and the autonomous travel is resumed in a case where the operation device receives the first operation.

7. The vehicle control method according to claim 1, wherein
in a case where it is determined that the situation outside acquired by the sensor device satisfies the first condition during the autonomous travel, it is displayed on the display device that at least one of deceleration and stop is possible by the brake operation, the autonomous travel is deactivated in a case where the operation device receives a second operation that is the brake operation, and it is displayed on the display device that the autonomous travel has been interrupted, and
in a case where it is determined that the vehicle stops by the second operation and the situation outside acquired by the sensor device satisfies the second condition after the autonomous travel is deactivated, it is displayed on the display device that the autonomous travel will be resumed when the brake operation is released, and the autonomous travel is resumed in a case where the operation device receives a third operation of releasing the brake operation.

8. The vehicle control method according to claim 1, wherein
the sensor device includes at least one of a camera, a sonar, a radar, and a LiDAR.

9. The vehicle control method according to claim 1, wherein
the autonomous travel is traveling along a parking path from a predetermined position to a target parking position.

10. The vehicle control method according to claim 9, wherein
the parking path is a path recorded in advance from the predetermined position to the target parking position.

11. A vehicle control device mounted on a vehicle including an operation device that receives an operation of an occupant, a sensor device that acquires a situation outside, a display device that is visually recognizable by the occupant, and a movement control device that controls at least acceleration and deceleration and steering, the vehicle control device comprising
a control circuit configured to:
cause the vehicle to perform autonomous travel by controlling at least the acceleration and deceleration and the steering based on the situation outside acquired by the sensor device;
decelerate the vehicle at a predetermined deceleration and stop the vehicle, deactivate the autonomous travel, and display on the display device that the autonomous travel has been interrupted, when determining that the situation outside acquired by the sensor device satisfies a first condition during the autonomous travel, and
display on the display device that the autonomous travel will be resumed when a brake operation is released after the brake operation, when determining that the situation outside acquired by the sensor device satisfies a second condition after deactivating the autonomous travel, and resume the autonomous travel in a case where the operation device receives a first operation of releasing the brake operation after the brake operation.

12. The vehicle control device according to claim 11, wherein
the first condition is that an obstacle has been detected in a traveling direction of the vehicle, and
the second condition is that the obstacle detected in the traveling direction of the vehicle has been no longer detected.

13. The vehicle control device according to claim 12, wherein
the obstacle is a person.

14. The vehicle control device according to claim 12, wherein
the control circuit is configured to:
in a case where the sensor device detects the obstacle a first distance away in the traveling direction of the vehicle during the autonomous travel, decelerate the vehicle at a first deceleration and stop the vehicle, deactivate the autonomous travel, and display on the display device that the autonomous travel has been interrupted; and
in a case where the sensor device no longer detects the obstacle after deactivating the autonomous travel, display on the display device that the autonomous travel will be resumed when the brake operation is released after the brake operation, and resume the autonomous travel in a case where the operation device receives the first operation.

15. The vehicle control device according to claim 14, wherein
the control circuit is configured to decelerate the vehicle at a second deceleration greater than the first deceleration and stop the vehicle in a case where the sensor device detects the obstacle a second distance away in the traveling direction of the vehicle during the autonomous travel, the second distance being shorter than the first distance.

16. The vehicle control device according to claim 11, wherein
the control circuit is configured to, when determining that the situation outside acquired by the sensor device satisfies the second condition after deactivating the autonomous travel, display on the display device that the autonomous travel is available, display on the display device that the autonomous travel will be resumed when the brake operation is released after the brake operation, and resume the autonomous travel in a case where the operation device receives the first operation.

17. The vehicle control device according to claim 11, wherein
the control circuit is configured to:
when determining that the situation outside acquired by the sensor device satisfies the first condition during the autonomous travel, display on the display device that at least one of deceleration and stop is possible by the brake operation, deactivate the autonomous travel in a case where the operation device receives a second operation that is the brake operation, and display on the display device that the autonomous travel has been interrupted; and
when determining that the vehicle stops by the second operation and the situation outside acquired by the sensor device satisfies the second condition after deactivating the autonomous travel, display on the display device that the autonomous travel will be resumed when the brake operation is released, and resume the autonomous travel in a case where the operation device receives a third operation of releasing the brake operation.

18. The vehicle control device according to claim 11, wherein
the sensor device includes at least one of a camera, a sonar, a radar, and a LiDAR.

19. The vehicle control device according to claim 11, wherein
the autonomous travel is traveling along a parking path from a predetermined position to a target parking position.

20. The vehicle control device according to claim 19, wherein
the parking path is a path recorded in advance from the predetermined position to the target parking position.
